(19) United States
(12) Patent Application Publication
(10) Pub. No.: US 2018/0225083 A1
(43) Pub. Date: Aug. 9, 2018

(54) METHODS, SYSTEMS, AND COMPUTER-READABLE STORAGE MEDIA FOR ENABLING FLEXIBLE SOUND GENERATION/MODIFYING UTILITIES

(71) Applicant: ScratchVox Inc., Toronto (CA)

(72) Inventors: Scott Barkley, Toronto (CA); Charlie Macchia, Toronto (CA)

(21) Appl. No.: 15/887,308

(22) Filed: Feb. 2, 2018

Related U.S. Application Data
(60) Provisional application No. 62/454,267, filed on Feb. 3, 2017.

(51) Int. Cl. G06F 3/16; G06F 3/0484; G06F 3/0482; G06F 3/0488

(52) U.S. Cl. CPC G06F 3/165; G06F 3/04883; G06F 3/0482; G06F 3/04847

(57) ABSTRACT

Systems and methods for enabling the generating and modifying of sound elements is provided. A sound engine includes or is linked to one or more sound modification interfaces that enable one or more users to access a digital waveform generator/modifier utility (“digital audio generator”, “digital envelope generator”), so as to graphically map aspects of that audio waveform's generation, by tracing one or more Bezier paths defined that can be processed by the sound engine, so as to define or modify aspects of the waveform, such as its frequency, pitch and amplitude envelopes, harmonic structure, the timing or pitch of component waveform elements, or directly upon the waveform. The sound engine enables user manipulation of the Bezier paths, including touch input modification of the paths (e.g. dragging, forming etc.) that define or modify fundamental qualities of the corresponding waveform.

### CROSS-REFERENCE TO RELATED APPLICATIONS

This application claims the benefit of U.S. Provisional Patent Application No. 62/454,267, filed on Feb. 3, 2017, the contents of which are hereby incorporated by reference in their entirety.

### TECHNICAL FIELD

This relates to computer systems for defining and modifying sound. This further relates to computer system-implemented musical defining/modifying tools.

### BACKGROUND

Applications for defining and/or modifying audio waveforms generally employ specific points or simple linear paths representing aspects of the tone's timbre, such as its frequency, pitch and amplitude envelopes, harmonic structure, the timing or pitch of component waveform elements. However, these are pixel-based representations that result in the user being limited in their ability to adjust the timbre or, if a Bezier path is used, for visualization purposes only. For example, the user may touch and drag, or click and drag a pixel-based, visualization-only path to move the path, but only within simple utility-defined constraints.

Typically, these pixel-based paths can be stretched, squeezed or repositioned, but the inherent structure of the path (for example a flat line or a simple curve) cannot be changed, or should a path be used for visualization purposes, the path at best roughly approximates what a true Bezier curved derived data would sound like, thereby severely limiting the user's ability to precisely define or modify a note's timbre.

Prior audio waveform defining and modifying utilities generally provide a limited ability to manipulate a waveform's timbre.

Further, there are numerous musical note-generating computer applications, or dedicated sound generating modules (sound engines—i.e. “keyboards) that employ a variety of audio resolutions or synthesis architectures (bit rate, sampling rate, or synthesis method—i.e. FM, subtractive, or the like). This varying of sound engine resolutions or synthesis techniques, from platform-to-platform and from manufacturer-to-manufacturer, limits the ability of the user to share key sound parameters (i.e. “patch” parameter) across different sound engines (i.e. ADSR envelopes, frequency envelopes, waveforms, etc.), thus making it difficult for digital music creators to collaborate across platforms.

### SUMMARY

In one aspect, there is provided a system for defining or modifying sound elements, comprising: (a) one or more computers; and a (b) sound defining/modifying utility (“sound modifying utility”) linked to the one or more computers, or accessible by the one or more computers, the sound modifying utility presenting, or initiating the presentation, on a display connected to the one or more computers, of one or more audio waveform defining/modifying graphical user interfaces (“interface”) that enable one or more users of the system to graphically map on the interface one or more musical elements as parametric representations thereof, wherein the parametric representations are encoded with information elements corresponding to the musical elements, wherein the parametric representations, and the encoded information elements, can both be defined or modified by the user in the interface in a flexible manner so as to enable the user(s) to define and modify sound entities that achieve a broad range of musical possibilities, in an easy to use and responsive manner.

In another aspect, there is provided a system for generating and/or modifying sound entities, the system comprising: one or more processors configured to provide a sound processing utility for generating and/or modifying sound entities; one or more computers linked to or accessible by the sound processing utility, a display connected to the one or more computers; wherein the sound processing utility is configured to present on the display one or more graphical user interfaces for waveform generation/modifying, wherein the one or more graphical user interfaces include a graphical map of one or more audio elements as parametric representations, wherein the parametric representations are encoded with information elements corresponding to audio timbre elements, wherein the parametric representations and the encoded information elements are definable and/or modifiable by the graphical user interface so as to enable generation and modifying of the sound entities, wherein the audio elements comprise the sound's timbre, such as frequency, pitch and amplitude envelopes, harmonic structure (i.e. overtone phase or micro tuning offsets), the timing or pitch of component waveform elements, or directly upon the waveform, and the parametric representations defined using Bezier paths.

In some embodiments, the parametric representations comprise parametric curves that define a path of curves.

In some embodiments, the musical elements comprise a waveform's timbre, such as its frequency, pitch and amplitude envelopes, harmonic structure, the timing or pitch of component waveform elements, or directly on the waveform.

In some embodiments, the system further comprises one or more audio processing components operable to play the sound entities.

In some embodiments, the parametric representations encapsulate information for displaying a path on the interface, and also encapsulate the information for playing the sound entities, and the parametric representations are modifiable based on user input to the interface such that modifications to the parametric representations make corresponding changes to the information for playing the sound entities.

In some embodiments, the parametric representations are generated using one or more processes that create scalable parametric paths, such that the encoding of the parametric representations with the information elements is scalable, thereby providing flexible and responsive system characteristics.

In some embodiments, the parametric representations are generated using Bezier paths.

In some embodiments, the sound processing utility creates calculation points for a parametric representation corresponding to the musical elements into a Bezier path (which may include linear components), stores the path, and if input is received from the interface to modify the parametric representation, more calculation points are added to the Bezier path corresponding to such input, or current calculation points may be modified, thereby enabling the modification of the sound entities such that smooth transitions are audible when the sound entities are played using an audio processing component.

In another aspect, there is provided an audio waveform defining/modifying tool incorporating the sound processing utility as described herein.

In some embodiments, the interface includes one or more grids, each grid including a timeline, and permitting the user to create parametric representations and placing them in the timeline so as to define or modify an audio waveform's timbre.

In some embodiments, the interface includes an amplitude grid, wherein the amplitude grid that is executable to allow one or more users to draw on the amplitude grid one or more paths corresponding to a note so as to create a spatial representation of amplitude attributes of sound elements that correspond to an associated amplitude spectrum.

In some embodiments, the interface includes a frequency grid, wherein the interface includes grid that is executable to allow one or more users to draw on the frequency grid one or more paths corresponding to a note so as to create a spatial representation of frequency attributes of sound elements that correspond to an associated frequency spectrum.

In some embodiments, the interface includes a phase overtone grid, wherein the interface includes a grid that is executable to allow one or more users to draw on the phase overtone grid one or more paths corresponding to a note so as to create a spatial representation of phase overtone attributes of sound elements that correspond to an associated phase overtone spectrum.

In some embodiments, the interface includes a relative pitch of overtones grid, wherein the interface includes grid that is executable to allow one or more users to draw on the relative pitch of overtone grid one or more paths corresponding to a note so as to create a spatial representation of relative pitch of overtone attributes of sound elements that correspond to an associated relative pitch of overtone spectrum.

In some embodiments, the interface includes a resonance grid, wherein the interface includes grid that is executable to allow one or more users to draw on the resonance grid one or more paths corresponding to a note so as to create a spatial representation of resonance attributes of sound elements that correspond to an associated resonance spectrum.

In another aspect, there is provided a computer implemented method for defining and modifying sound elements comprising:

(a) displaying one or more audio waveform's defining/modifying graphical user interfaces (“interface”) implemented to one or more computers including or being linked to a touch screen display;

(b) receiving one or more selections relevant to one or more musical elements using the interface;

(c) generating one or more parametric paths corresponding to the selections and encoding the musical elements; and

(d) storing the parametric paths so as to define one or more executable sound entities, wherein the sound entities can be defined or modified using the interface in a flexible manner so as to enable the defining or modifying of the sound entities so as to achieve a broad range of musical possibilities.

In another aspect, there is provided a method, wherein the interface includes one or more grids for the defining or modifying aspects of a waveform's timbre (such as its frequency, pitch and amplitude envelopes, harmonic structure, the timing or pitch of component waveform elements, or directly upon the waveform); comprising:

(a) accessing, including iteratively the grids so as to define or modify an audio waveform's timbre attributes for one or more sound entities;

(b) receiving input using the interface that the definition or modification of the timbre attributes have been completed; and

(c) storing of more sound entities defined by the selection of the audio waveform's timbre attributes to a data store, thereby providing one or more executable sound entities based on such audio waveform's timbre attributes.

In another aspect, there is provided a system for sharing the Bezier-defined timbre information between platforms whose sound engines employ varying resolutions (bit rate, sampling rate) and synthesis methods (subtractive, FM and additive, or the like).

It is to be understood that this disclosure describes example embodiments. The present invention is not limited to the specific details, features, and arrangements of the components set forth in the following description or illustrated in the drawings. The invention is capable of other embodiments and of being practiced and carried out in various ways. Also, it is to be understood that the phraseology and terminology employed herein are for the purpose of describing example embodiments and should not be regarded as having any limiting effect on the scope of the invention or claims.

### BRIEF DESCRIPTION OF THE DRAWINGS

Example embodiments are described herein with reference to the drawings, in which:

FIG. 1 shows an example of a Bezier path representation of a musical note's Attack, Decay, Sustain, Release (ADSR) envelope;

FIG. 2 shows an example of a Bezier path representation of a musical note's waveform;

FIG. 3 shows an example of a Bezier path representation of a musical note's low pass/band pass/high pass filter envelope;

FIG. 4 shows an example of a Bezier path representation of musical note's phase overtone;

FIG. 5 shows an example of a Bezier path representation of musical note's relative pitch of overtones;

FIG. 6 shows an example of a Bezier path representation of musical note's resonance;

FIG. 7 shows a pixel-path-to-Bezier-path relationship;

FIG. 8 shows an example method for modifying the Bezier paths;

FIG. 9 is a system diagram of an example client implementation of a computer system according to some embodiments;

FIG. 10 is a system diagram of an example client/server implementation of a computer system according to some embodiments;

FIG. 11 shows an example distribution schematic for sharing Bezier-based waveform or timbre descriptions with a variety of sound engines that employ different resolutions (bit rate and sampling rate) and synthesis methods (subtractive, FM and additive, or the like), according to some embodiments;

FIG. 12 shows an example of how a playhead on a GUI timeline may control timbre generation from the underlying Bezier path;

FIG. 13 shows an example Bezier path that describes timbre, and the node and node ‘handles’ (tines) modification thereof; and

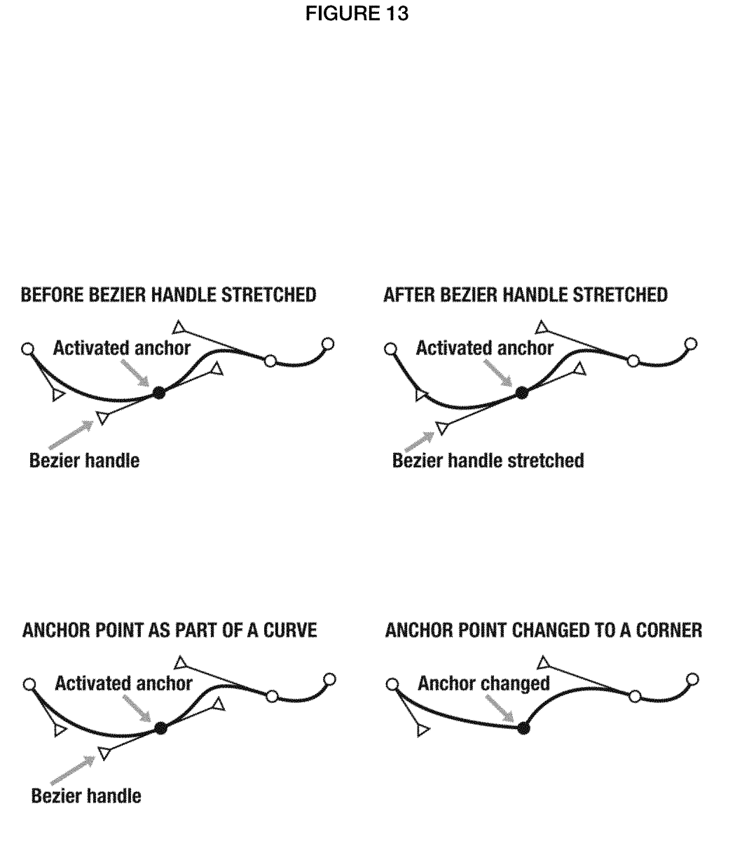

FIG. 14 shows an example of the Attack, Decay, Sustain and Release (ADSR) of a timbre represented by four separate paths for use with additive synthesis.

In the drawings, embodiments of the invention are illustrated by way of example. It is to be expressly understood that the description and drawings are for the purpose of illustration and as an aid to understanding, and are not intended to have a limiting effect

### DETAILED DESCRIPTION

There is a need for a system and method that allows for defining and modifying a waveform's timbre functionality that is more flexible and responsive to users than known systems. There is a further need for systems and methods for defining and modifying waveforms which are suitable for use with touch interface computers.

It would also be advantageous to have an improved system for defining and modifying an audio waveform that improves on or does not suffer from one or more of the drawbacks of prior systems. This is particularly true in recent years given the widespread use of computing devices which use touch interfaces.

There is also a need for a sound parameter sharing technology (i.e. keyboard “patch” parameter technology) that is highly flexible in its resolution and that can operate separately of the synthesis method.

While it may not be possible to entirely share sound “patch” parameters across completely different synthesis techniques, the use of digital resolution-independent and synthesis method-independent “patch” parameters can (where function overlap is possible, typically with regards to envelopes i.e. ADSR, frequency filters) greatly enhance inter-user and inter-synthesis platform sharing and collaboration. This is due to the inherent resolution independence mathematically built into Bezier paths as they are—for most if not all practical audio purposes—of mathematically infinite resolution.

In one aspect of the invention, a computer system, computer implemented method and computer program is provided that enables the defining and modifying of an audio waveform's timbre. Note that given the computing power of modern digital keyboards or sound modules, these devices may also be considered to be computers within the context of this application.

In one aspect of the invention, the computer system and computer implemented method may provide a mechanism for defining and modifying an audio waveform's timbre, as described below.

In one aspect of the invention, the computer system includes at least one computer, the computer linked to a touch input device, the computer including or being linked to an application or an application repository that provides a sound engine; the sound engine when executed presents one or more audio waveform's timbre interfaces or screens including or being linked to one or more audio waveform's interfaces, that enable one or more users to access an audio waveform's definer/modifier, so as to graphically map one or more timbre parameters by tracing one or more paths defined by Bezier paths and then processable by the audio generator so as to define a musical note's timbre that includes, but is not limited to, its frequency, pitch and amplitude envelopes, harmonic structure, timing or pitch of component waveform elements, or the waveforms themselves.

According to some embodiments, the system and method may be easy to learn to use. Some embodiments provide a more intuitive way of defining and modifying an audio waveform's timbre where “the eye meets the ear”.

In one aspect of the present invention, there is provided a touch-based graphical user interface (GUI). In some embodiments the GUI is provided as a touch screen interface. The GUI is linked to a computer program component that allows one or more users, based on touch input, to make one or more selections associated with such musical information elements, and these selections are displayed on the GUI. These representations include, are based on, or are linked to, a plurality of parametric curves defining a “path” that encodes information corresponding to the musical information elements.

In another aspect of the invention, a process or algorithm is used for defining these curves and paths such that the encoding of the curves/paths can be easily, minutely and precisely modified. In some embodiments, Bezier paths have been selected so that the paths are readily modifiable because Bezier paths can be endlessly modified. The musical information elements, in some embodiments, are stored as algorithms comprising Bezier paths, which may result in enhanced flexibility and responsiveness.

One aspect of the invention is a computer implemented method for encapsulating data that relates to a note. In some embodiments, the note is a musical note.

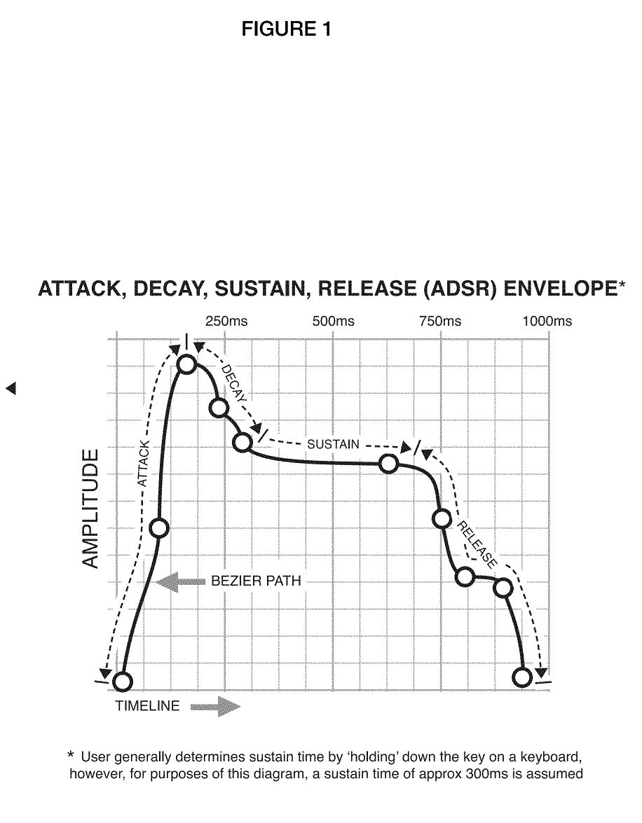

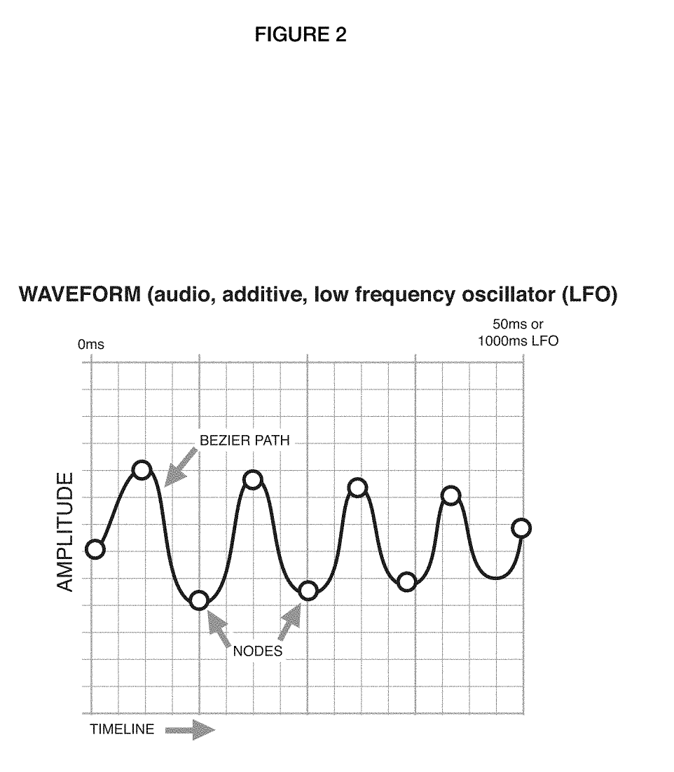

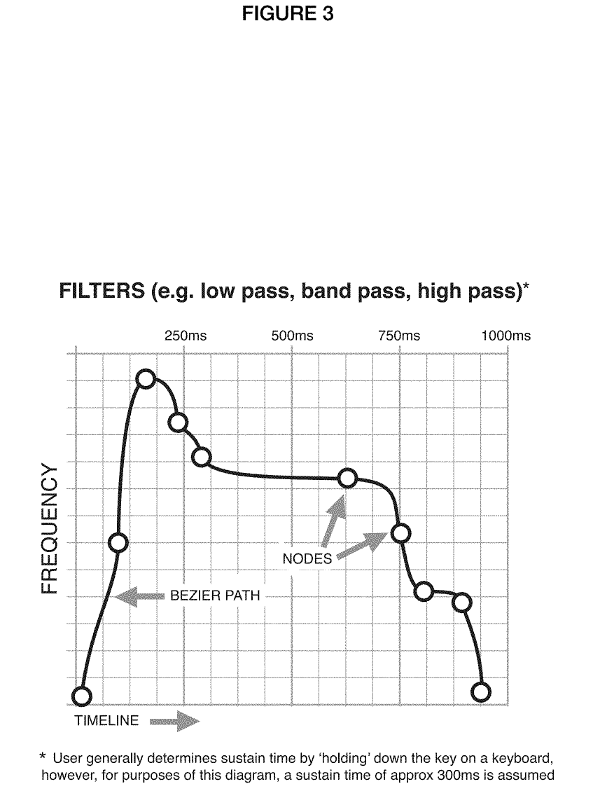

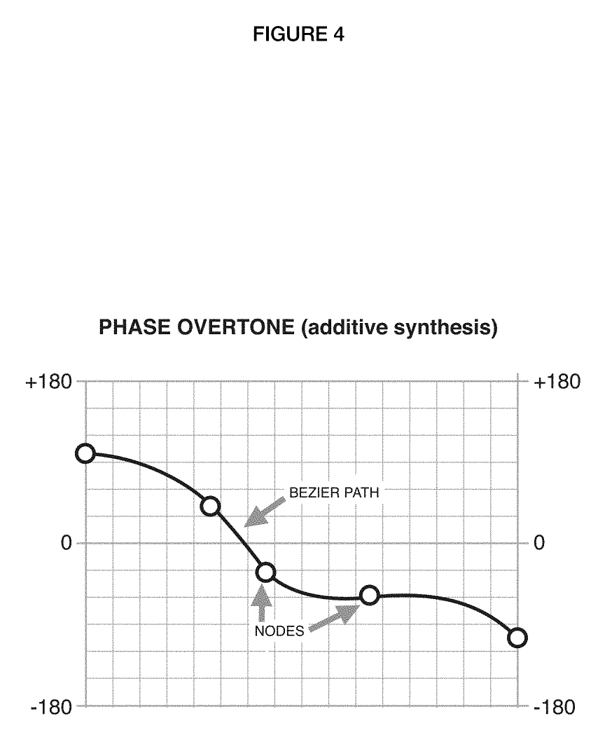

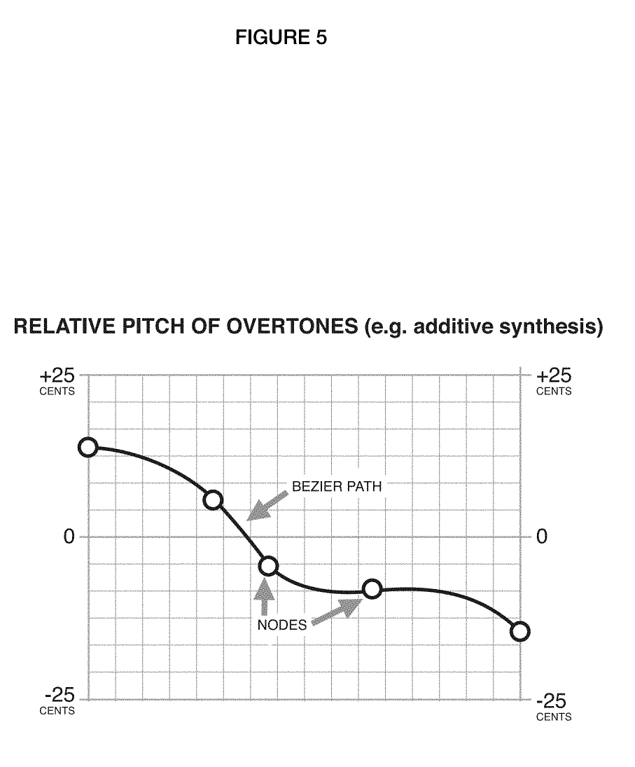

In one aspect, the present invention presents easy-to-understand grids that accurately display the audio waveform's timbre as shown in FIGS. 1-6.

Some embodiments allow for the creation of an audio waveform's timbre using applications that follow best practices in software design, and may significantly improve the encapsulation of musical information into a representation of an associated audio waveform.

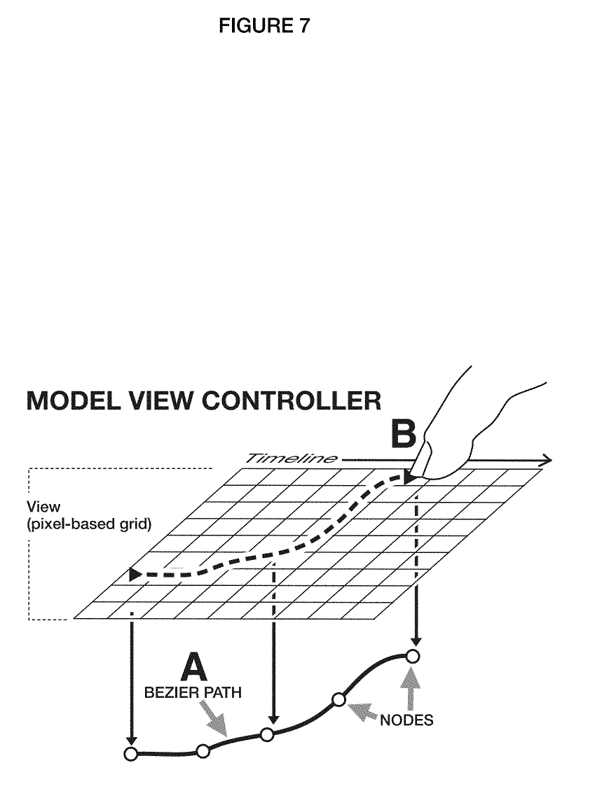

In another aspect, some embodiments take the audio waveform's timbre information (which is normally represented in most audio waveform timbre programs as loosely related pixel-based paths, linear paths, or may use a Bezier curve for display purposes only), and instead converts this information into an accurate, precisely modifiable and more intuitive Bezier path ‘model’ object (see, e.g., FIG. 7). The Bezier path can be a curve having an arbitrary node count and a node type. This greatly expands the ability to define and modify a musical note's timbre, because the user can draw intricate Bezier paths to express intricate variations in timbre.

In another aspect, some embodiments adopts Model-View-Controller (MVC) techniques, as shown in FIG. 7. In some embodiments, this MVC pattern is used to calculate from that which is drawn on a suitable graphical user interface (GUI) displayed on a touch screen (such as the screen of a mobile device, tablet computer, touchscreen of a laptop computer, or desktop computer or musical instrument) to create an underlying Bezier path or model object or Bezier model object. The GUI provides a control surface or “view” that is used by users to define/modify an audio waveform's timbre.

When the Bezier model object is then displayed on the control surface, what is displayed may appear to be merely the pixels that the user has drawn using their finger or a stylus. But the underlying model object encapsulates or holds all data required to accurately display the path on the control surface and generate any data necessary to play the path accurately with an audio engine. The user may endlessly manipulate what is displayed in the view or control surface, but these manipulations are interpreted as actions on the underlying mathematical Bezier Model object Therefore some embodiments are implemented such that the underlying Bezier model objects have an arbitrary degree of resolution. Thus, the Bezier model objects can be used to precisely define and precisely and intricately modify timbre, unlike prior loosely-related pixel representations, and linear or Bezier paths used for display purposes only. Further, the underlying Bezier model object may not ever lose its identity short of being erased.

The mathematical descriptions and/or definitions of the underlying curved Bezier paths are used to calculate the musical note's timbre as required anywhere along the curves of the Bezier path, to an arbitrary degree of resolution.

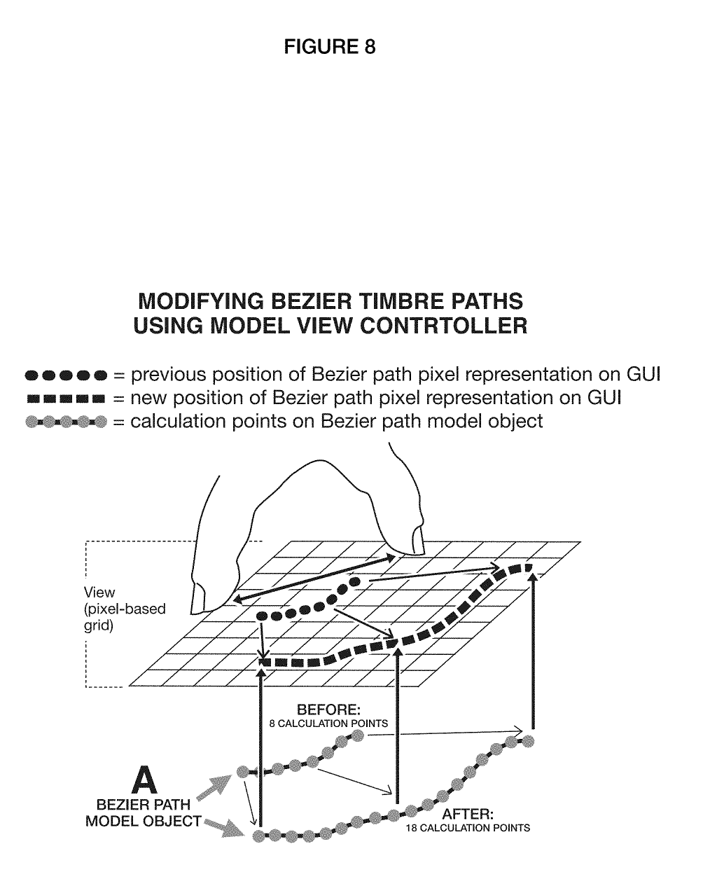

Some embodiments of the systems and methods disclosed herein may define and modify an audio waveform's timbre by placing sufficient calculation points along its Bezier paths to create a smooth and pleasing sound. When its paths are modified or stretched (as shown, e.g., in FIG. 8), the some embodiments simply add or subtract calculation points along the Bezier path, which may keep the sound smooth and pleasing. This is possible because a Bezier path's algorithms allow it to be infinitely modified.

According to some embodiments, the Bezier paths and therefore the musical note timbre can be endlessly modified and yet have the surprising result of maintaining not only an accurate timbre description, but maintaining audio fidelity. Thus, in some embodiments, the audio waveform's timbre descriptions are resolution independent

Therefore, some embodiments are not dependent on pixel-based path relationships, as represented in the display view, to define and modify timbre. This may result in the user being able to precisely and intricately define and modify timbre. The sophisticated use of the Model View Controller patterns to generate mathematical Bezier model objects may improve or overcome the constraints created by pixel-based representations in prior musical note timbre defining/modifying programs.

As shown in FIGS. 1 to 6, some embodiments may use many time-aligned grids to display a musical note timbre's frequency, pitch and amplitude envelopes, harmonic structure, timing or pitch of component waveform elements, or the waveforms themselves. It should be noted that duration is simply the length of the paths along the timeline.

Furthermore, as shown in FIG. 7, the system and method can include a GUI that is linked to a Model View Controller that allows a user to modify the underlying curved model Bezier paths into any description of a musical note's timbre through the manipulation of their pixilated representations on the GUI. This allows for example for novel timbre modulations effected by the manipulation (stretching, rotating, copying, twisting, or the like) of the note's Bezier path descriptions of timbre as shown in FIG. 8, thereby permitting highly flexible user interaction with musical content.

The systems and methods described herein may be implemented as a number of different computer systems and computer implemented methods. For example, an audio generator according to some embodiments may be implemented as computer program implemented on a mobile device, a tablet computer, laptop computer, desktop computer, musical keyboard or module. The audio generator may also be implemented as an Internet service, for example a cloud networking-implemented online service. Further example embodiments are provided below.

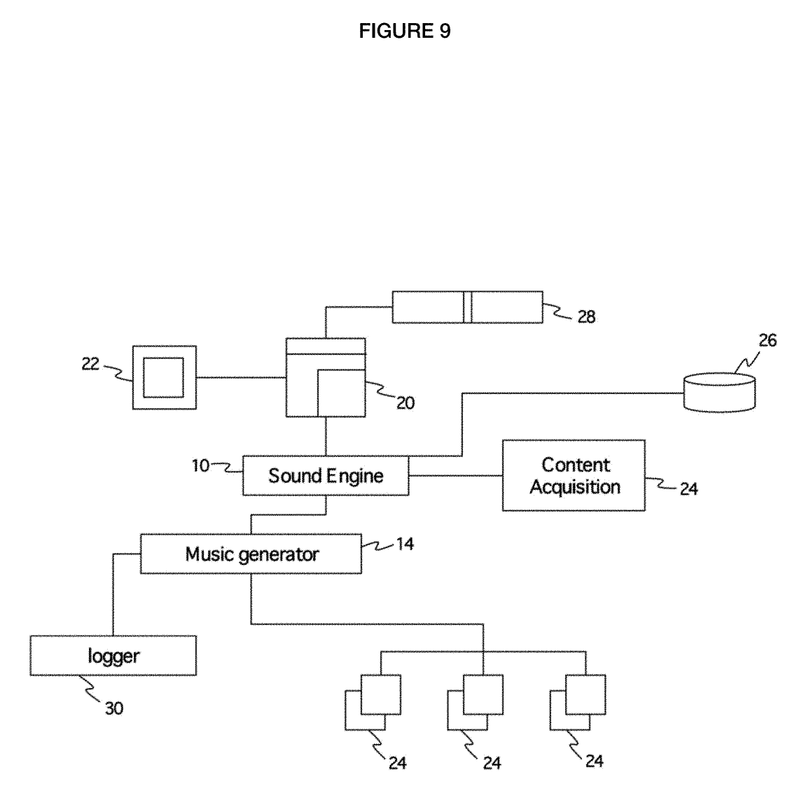

FIG. 9 is a system diagram of an example client implementation of a computer system according to some embodiments. The system may be implemented as a computer program on a computer-readable storage medium that, when executed by one or more processors, causes the processors to provide a sound engine (10).

In some embodiments, the sound engine (10) includes one or more audio waveform timbre interfaces that enable flexibility in defining timbre parameters. For example, for an Attack, Decay, Sustain, Release envelope. The sound engine (10) may be implemented to or made available to any manner of computer device (20). The computer device is linked to a touch display (22).

More particularly, the sound engine (10) may rely on and/or incorporate an audio waveform timbre definer/modifier The audio waveform's timbre definer/modifier component can perform a process for generating an audio waveform's timbre, as described herein. Significantly, the audio waveform's timbre definer/modifier component may also perform a process for controlling a note's timbre, for example by using the audio waveform's timbre defining/modifying interfaces (12) described below.

The audio generator may also be used to modify existing musical content, for example as provided by the content acquisition component (24).

A logger (30) may be linked to the music generator (14) to track user interactions with the sound engine (10) based on the methods described herein.

More particularly, the audio waveform's timbre definer/modifier component may incorporate one or more computer implemented methods for graphically mapping one or more audio waveform timbres by using one or more music mapping GUIs (18) for (A) displaying the waveform's timbre based on Bezier paths relating to frequency, pitch and amplitude envelopes, harmonic structure, timing or pitch of component waveform elements, or the waveforms themselves; and (B) enabling the user manipulation of the paths, for example using touch input modification of the path (e.g. dragging, forming etc.) and thereby modifying a waveform's timbre and components thereof.

The audio waveform's definer/modifier may enable user modulation in a transparent way. The use of the audio waveform's definer/modifier is intuitive, and the Bezier path-based definition/modulation of timbre enables the shifting of timbre attributes in a highly flexible way, thereby enabling improved experimentation with musical elements. This may allow the user to create a series of musical content components (26) or “sound entities”, which are easy to create and modify.

In some embodiments, the audio waveform's definer/modifier defines an area in a GUI presented on a touch screen (22) that allows a user to define/modify a range of timbre possibilities using their finger or a pointing device, e.g. a stylus.

It should be understood that the paths referred to herein include Bezier paths that are defined by mathematical algorithms, and the sound engine (10) is operable to define and modify audio waveform's timbre using these paths.

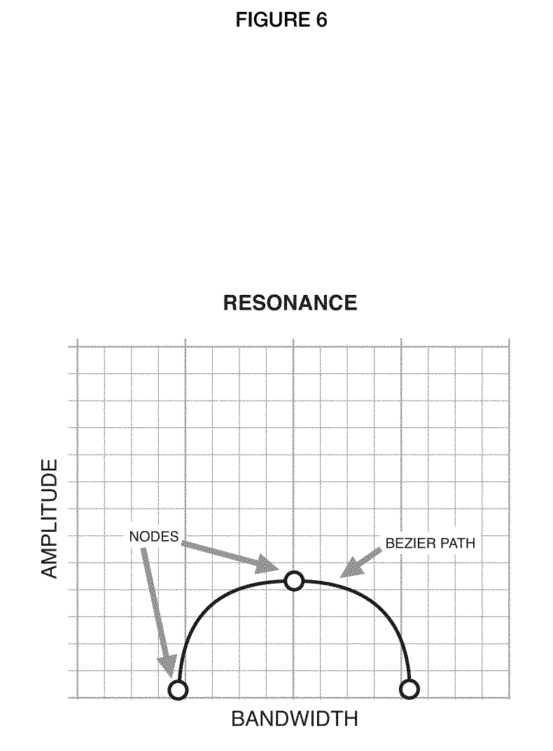

Referring to FIGS. 1 through 6, six example music mapping GUIs are illustrated. These music mapping GUIs enable the definition and modification of paths that define and modify a musical note's timbre attributes. One or more suitable Bezier path-based drawing methods or technologies are used to trace the paths described. In the case of FIGS. 1 through 5, the paths indicate variations of timbre over time. In FIG. 6, the path describes resonance that applies to a specific area of an Attack, Decay, Sustain, Release (ADSR) envelope.

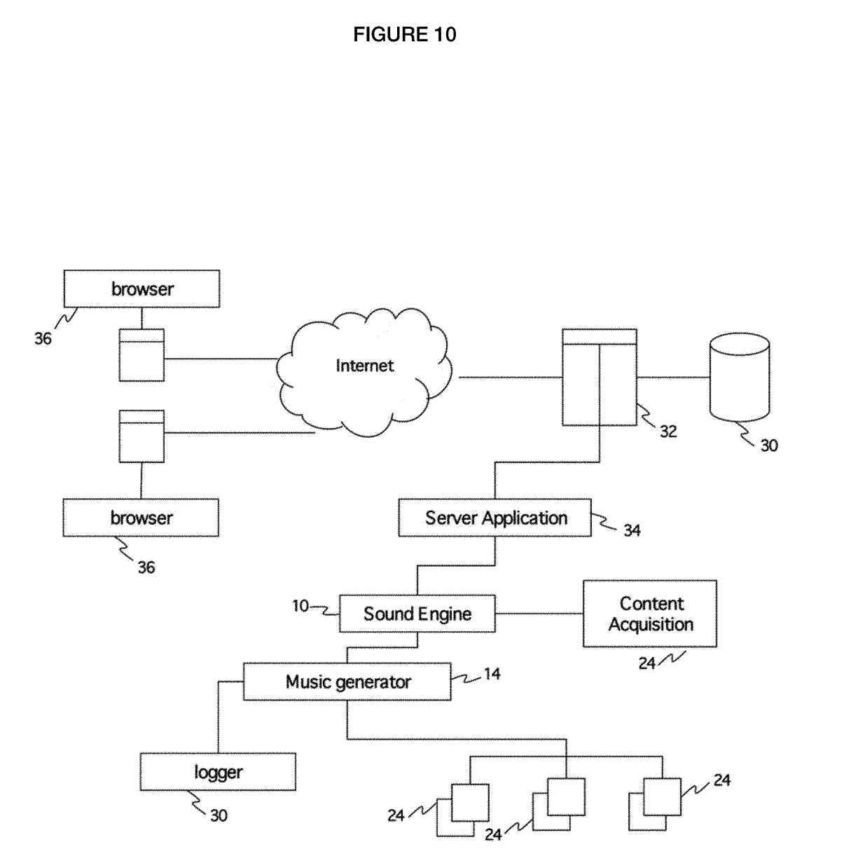

FIG. 10 illustrates a client/server computer implementation according to some embodiments of the present invention. The sound engine (10) may be implemented as a server application (34) which may be loaded on a server computer (32). A database (30) may be connected to the server computer (32). Multiple network-connected devices, each having a touch screen, connect to the resources of the server application (34) via the Internet using a browser (36). The server application (34) may also be implemented as an application repository.

It should be appreciated that various other computer system architectures are possible for implementing various variants and embodiments.

In one aspect of the invention, an easy-to-use and flexible audio waveform timbre defining/modifying interface is provided. Possible embodiments are illustrated in FIGS. 1 through 6, and FIG. 8 shows how a user can modify au audio waveform's timbre by modulating Bezier paths.

In some embodiments, a program interface or web interface may include or display one or more menus that enable a user to select from different music mapping GUIs that define attributes that collectively define how a path or paths are played. In some embodiments, the system can include one or more tools that enable the navigation between a plurality of Bezier paths that may define for example an ADSR or low-pass filter envelope. The paths may, in some embodiments, be represented as a series of sounds that are arranged in a sequence (indicating that sounds are intended to be played sequentially, one after another, as a single-note melody) or in parallel (indicating that sounds are intended to play at the same time or partially at the same time as multi-note harmonies). Various other arrangements are possible.

A skilled reader will understand that the present invention contemplates various different types of musical note timbre interfaces and associated features and user workflows. One aspect of the invention is an audio waveform's defining/modifying interface of various types that can be based on or incorporate the computer implemented methods of the present invention.

In some embodiments, the sound engine (10) can enable the definition of duration parameters. By enabling user configurability of timbre duration, the computer system may provide a highly flexible, highly tunable system for defining and modifying audio waveform's timbre, in one implementation.

It should be appreciated that some embodiments of the present invention permit complete and fluid sound tunability, for example complete and fluid timbre control. It follows from this tunability and control that users can also modify existing musical content with the same complete and fluid timbre control, thereby enabling users to import source files and modify these source files based on user intent, without the limitations to timbre and exploration by users that prior systems suffer from.

In some embodiments, the computer system may include an audio content acquisition component (24) that is operable, for example, to acquire musical content for modification using the audio waveform builder component For example, the audio content acquisition component (24) may be operable to acquire audio content such as an acoustic musical instrument.

The audio content acquisition component (24) may be operable to pre-process the audio content (e.g. convert to Bezier path descriptions of its timbre), to enable processing by the systems and methods described herein. For example, the audio content acquisition component (24) can acquire one or more source tones from a library or other source, and then the timbre of the source tones can be modified, as described, and thereby create musical content from a collection of such tones.

Significantly, a Bezier path illustrated by operation of the GUIs shown in the Figures can map precisely to an audio waveform's timbre. The timbre may be changed by altering the path. A user may selectively modify an audio waveform's timbre by selectively altering the corresponding paths, as illustrated, for example, in FIG. 8.

Some embodiments of the computer system and computer implemented method of the invention may provide significant malleability, thereby creating an unmatched, immersive, dynamic and exciting audio experience, with particular emphasis in the musical realm. Using the audio mapping GUIs according to some embodiments, users can (a) draw a timbre; (b) copy a timbre; (c) incrementally roughen, rotate, stretch a timbre, and so on. Each of these changes to the visual paths depicted herein result in modification of the sound entity represented by the paths. In this way, the musical mapping GUIs constitute an graphical overlay, where each points maps to a timbre parameter. The sound engine (10) includes a logger (30) that is operable to log the musical parameter selections represented by the paths so as to enable the sound engine (10), based on these selections to modulate sound output.

The present invention includes the conception of the idea that state of the art in audio processing, enables additive synthesis to re-create the extremely complex waveforms of natural audio tones, as opposed to the simple modification of stored musical content (i.e. samples) or basic oscillators. To this end, the sound engine of the present invention builds and rebuilds the audio waveform's timbre, mapped to current Bezier path positions, thereby creating a highly responsive and expressive musical environment

Another aspect of the present invention is the realization that Bezier paths can be used as a user interface metaphor for controlling and shaping an audio waveform's timbre, so as to enable user manipulation of note timbre within an extensive range. This may provide an extensive timbre palette for creating music compositional elements.

Some embodiments have the innovative and surprising result of providing a computer system and an easy to use GUI that enables users to bypass the more limited flexibility that is inherent in previous audio waveform timbre defining/modifying computer programs, particularly with regard to touch interfaces.

According to some embodiments, the computer program of the present invention utilizes Bezier paths to instantly and precisely play any combination of audio waveform timbre definitions/modifications that a user can imagine. The computer program provides unprecedented levels of audio waveform timbre creative control in the hands of users.

Controlling audio waveforms through the use of Bezier paths, as described herein, may provide unprecedented dexterity.

Another important innovation provided by some embodiments is the storing and sharing of waveform and waveform modifying information (e.g. envelopes) as Bezier path descriptions. As mathematical descriptions, these paths may have infinite or close to infinite resolution, and therefore have the ability of potentially driving any sound engine that can accept these Bezier paths, regardless of the native resolution of the sound generator. This significantly includes not only current sound engines, but also sound engines that have yet be developed. This cross-platform agility of Bezier timbre descriptions therefore has the potential to become a new musical timbre description standard for the industry.

It should be appreciated that path-based Bezier timbre descriptions (i.e. envelopes or the like), could potentially be interpreted with all current popular musical note synthesis systems, including subtractive, FM and additive synthesis. It should also be appreciated that some embodiments are operable to cover the complete range of frequencies audible to the human ear.

Bezier waveforms generated by some embodiments may be used to create music composed by the user. This user-created music may be stored on database (34), as shown in FIG. 10, and may be shared in a number of ways. For example, the user-created music may be shared via a social networking environment linked to the server computer (32). The server application (34) can also enable collaboration between users of two or more computers, who may access one or more collaborative composition workflows enabled by the sound engine (10).

It should also be appreciated that the musical note timbres created by operation of some embodiments are highly responsive. Some embodiments allow the dynamic creation and modification of musical note timbre, which may enable aspects of musical virtuosity beyond what is possible using musical instruments or prior musical note timbre defining/modifying technologies. The present technology may open the door to radically new expressions of timbre.

Some embodiments provide a method of musical note timbre defining/modifying that uses Bezier paths (defined using the GUI) to define musical note timbre. These paths enable precise definition and modification of complex musical note timbres. These variations may be modulated instantly or close to instantly by operation of the systems and methods described herein.

One distinction between some embodiments and prior system is that some embodiments use mathematical descriptions of Bezier paths to store and instantly play back any variation of an audio waveform's timbre. This may allow the systems and methods described herein to be complete, instantaneous, precise and flexible. Manipulation of a note's paths by a user may effect a corresponding and immediate modulation of its assigned audio waveform qualities. Such audio waveforms may be particularly useful in music, where thematic variation and progression of sound is extremely important; and it is here where the benefits of some embodiments may shine, by creating audio waveforms that are highly tunable by modification and repetition of paths.

In some embodiments, the computer system is adapted to enable a user to manipulate the timbre paths, as a group, as a single path, or a section of a path. The computer system supports one or more such manipulations by the user, for example a path or a section of a path or a group of paths or any combination of paths and sections of paths may be incrementally nudged, rotated, flipped, flopped, roughened, bloated, stretched, squeezed, twisted, zig-zagged, warped, and any combination thereof.

According to one aspect of the present invention, a Model View Controller system may generate audio waveforms based on the algorithms of underlying curved model Bezier paths that describe the audio waveform's timbre (as show, for example, in FIGS. 1 to 8).

Following the capture of the original drawing points from “View” components, all further displays of the data to the user through the software's “View” components, are in fact, actually representations of the underlying calculated Bezier model objects.

Some embodiments use the timbre grid view only as a frame of reference to determine timbre parameters of a Bezier path that is generated to the user's input finger/stylus drag across the GUI, illustrated by point B in FIG. 7. The Bezier path is a complex multi-node path of arbitrary node length and also type. For example, nodes on the Bezier path can be linear, quadratic, or cubic in nature. The Bezier path is maintained in memory as such for future playback or modulation.

The Bezier path illustrated as element A in FIG. 7 is interpreted and displayed on the GUI, not the original finger drag/stroke (although the two may look similar or even the same on the GUI). It is the use of this malleable underlying Bezier path that allows the displayed stroke to be modified into any audio waveform description.

Since the Bezier path maintains its coherent identity through a mathematical relationship to a set of nodes, it is possible to manipulate the path shape while having it maintain its general shape. The path can be smoothly and infinitely stretched, shrunk, deformed, copied, moved, or the like, while still maintaining audio waveform descriptions that are accurate to its current modification, allowing for accurate data from any point on the curve to continue to be gathered, maintaining the fidelity of note quality.

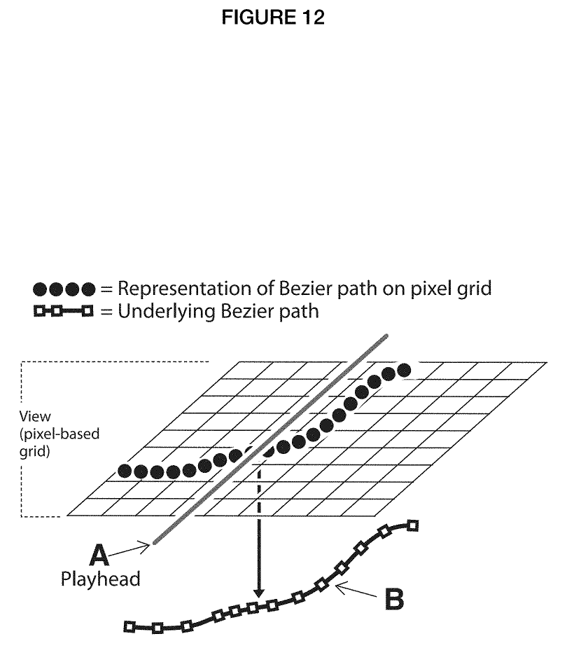

Some embodiments of the computer system may present a conventional playhead, as illustrated as element A in FIG. 12. Some embodiments may present a UI component that shows the current progression of play of musical content which is modified to move across the grid's timeline and encounter the start of a Bezier path. The waveform played is generated by means of mathematical calculation of points along the path (as illustrated by element B in FIG. 12). Example calculation methods are described herein. These calculations may be made on-the-fly, or may exist as a pre-calculated set of points to be referenced. The calculated waveform is then played by means of proprietary commands to the waveform generator, or translated into a standards-compliant audio format.

This may result in the capability of having infinite or near infinite and intricate waveform descriptions and modifications: calculation points are varied in their time intervals along the curved Bezier paths. It is important to note that these calculation points have no relationship to the pixels on the view timbre grid.

Some example calculation methods which may be used are now described. It should be noted that calculation methods are not limited to those detailed below, and that other variants are contemplated.

Some embodiments of the present invention take the path drawn onto the touch surface by the mouse, finger or stylus and convert it into a multi-node Bezier path, which can represent many aspects of an audio waveform, including one or more of:

a) A description of the actual waveform itself.

b) Overtone series.

c) Overtone phase.

d) Overtone amplitudes.

e) Overtone envelops (pitch or amplitude)

f) Overtone pitch.

g) Pitch envelope.

h) Filter envelope.

i) ADSR of the entire waveform itself (“Attack, Decay, Sustain, Release” but going well beyond simply these defined points)

j) ADSR of any selected set of waveform components (in particular with respect to additive synthesis)

k) Pitch and Filter envelopes of any selected sub-set of waveform components.

The Y position along the Bezier curve is calculated in relation to a given percentage value input, between one node to another . An example of the calculations in the case of a Cubic Bezier Node (the most common node type) is given below:

Where t=a position between nodes, given as a percentage, along a cubic Bezier path segment.

t=(x−StartPoint.x)/(EndPoint.x−StartPoint.x);

F.sub.1(t)=t.sup.3

F.sub.2(t)=3t.sup.2(1−t)

F.sub.3(t)=3t(1−t).sup.2

F.sub.4(t)=(1−t).sup.3

These equations are then combined:

pX=StartPointX*F.sub.1(t)+ControlPoint1X*F.sub.2(t)+ControlPoint2X*F.sub.−3(t)+EndPointX*F.sub.4(t)

pY=StartPointY*F.sub.1(t)+ControlPoint1Y*F.sub.2(t)+ControlPoint2Y*F.sub.−3(t)+EndPointY*F.sub.4(t)

Where: F.sub.1 are the Bezier functions, F.sub.1, F2, F3, F4 above t is a percentage of the distance along the curve (between 0 and 1) which is sent to the Bezier functions F.sub.1, F2, F3, F4 p is the point in 2D space, we calculate for X and Y, and then combine to make the point

These calculations can take place on-the-fly, or can generate a pitch lookup table of arbitrary resolution.

Some embodiments may incorporate path modulation methods. Music composition can require variations of a note or group of notes' waveform(s). Some embodiments enable variations of notes or groups of notes' waveforms by applying to their associated paths the path modification methods provided herein.

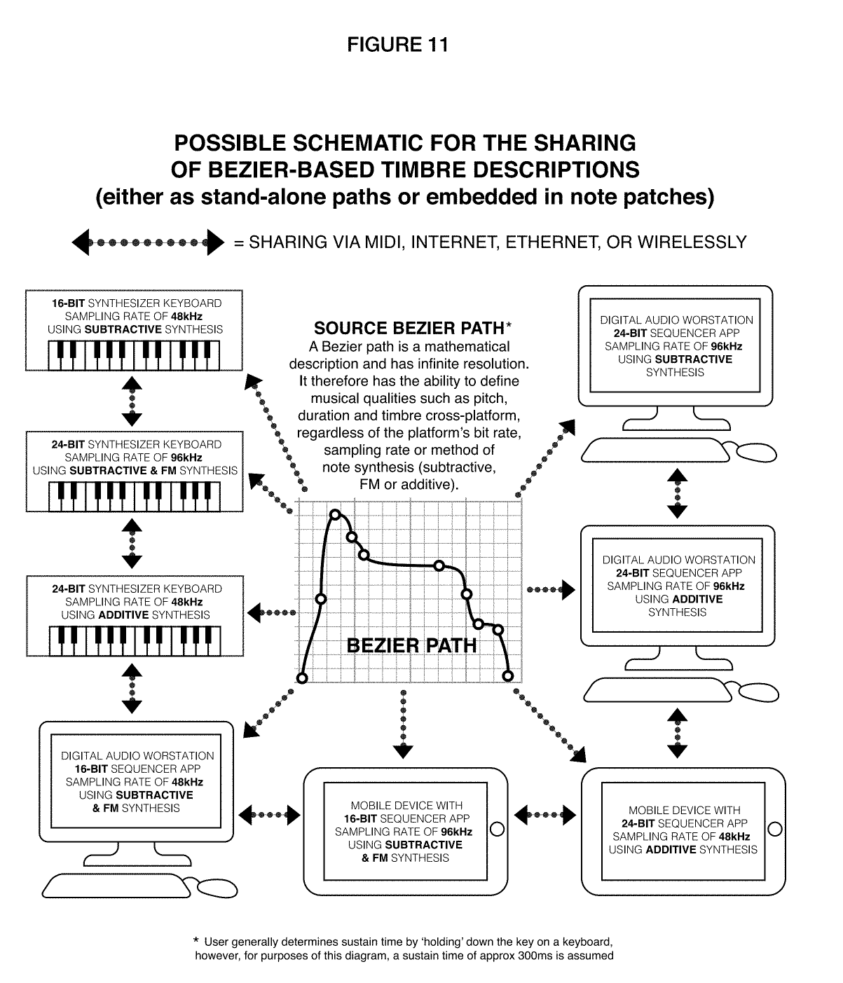

All paths drawn (straight or curved) can be Bezier paths with anchor points. Anchor points, sections of paths between anchor points, and whole paths can be selected. Anchor points can be changed from a rounded to corner point, as shown in FIG. 11, in some embodiments. Anchor points can also be added anywhere along an existing path to enable further modulation.

An individual anchor point on a curved path or at the end of a curved path can be selected to show its Bezier handles. A section of a path between two anchor points can also be selected to show the Bezier handles related to that section of path. These handles can be moved to change the curve of an individual path, for example, as shown in FIG. 11.

Whole paths and/or sections of paths can also be selected individually either sequentially or discontinuously by selecting a specific path nodes or path sections between nodes and can be then dragged or nudged into new positions.

Whole paths and/or sections of paths can also be modified by methods including but not restricted to:

Path Modification Method 1: Paths and/or section(s) of paths can be deleted.

Path Modification Method 2: Paths and/or section(s) of paths can be copied and pasted within its timbre grid or into a new timbre grid.

Path Modification Method 3: Paths and/or section(s) of paths can be stretched and compressed both horizontally and vertically.

Path Modification Method 4: Paths and/or section(s) of paths can be selected and moved intact and incrementally within their grids.

Path Modification Method 5: Paths and/or section(s) of paths can be incrementally rotated.

Path Modification Method 6: Paths and/or section(s) of paths can be flipped both horizontally and vertically.

Path Modification Method 7: Paths and/or section(s) of paths can be incrementally scaled up and down in size.

Path Modification Method 8: Paths and/or section(s) of paths can also be modified by filters and/or their incremental application. These filters include but are not restricted to: free distort, pucker & bloat, twist, zigzag, roughen, warp variations, duplication using predefined offset variations, and variable-stepped blending between two selected paths.

According to one aspect, the present invention may be implemented as a computer program stored on a non-transitory computer-readable storage medium which is executed by one or more processors. The computer program may be implemented as a tablet application, or mobile application or desktop application. Each of these may connect to the Internet to access computer network implemented resources through a server computer. For example the server computer may be used to access source files from an online library, store musical content to a cloud database, or to access collaborative features.

Some embodiments may be implemented based on various centralized or decentralized architectures. The Internet or any other private or public network (for example, an intranet) may be used as the network to communicate between the centralized servers and the various computing devices and distributed systems that interact with it.

Some embodiments may also be operable over a wireless infrastructure. Modern wireless devices are often provided with web browsing capabilities, whether through WAP or traditional means.

As skilled reader will appreciate that numerous variations are possible and contemplated by the present disclosure.

For example, the sound engine (10) may be implemented in a collaborative fashion so as to enable two or more users to compose music together using collaborative music mapping GUIs.

In order to access to the sound engine (10), the operator of the web platform including the sound engine (10) may require users to subscribe to the platform. Various models may be used to monetize the platform, including, for example, subscription fees, freemium models, or the placement of advertising in web pages associated with the web platform.

It should be understood that the functionality described may be integrated with a range of different musical audio waveform defining/modifying tools, whether by incorporating embodiments described herein into third party musical audio waveform defining/modifying packages in the form of software, or implementing the functionality described as a web service that is linked to third party musical audio waveform defining/modifying platforms or services. The present invention is not limited to any particular implementation of, or use of, the technology described.

For example, synthesizer keyboards, digital audio workstations, disc jockey (DJ) apps and mobile music creation apps may all be enhanced by integrating the present invention as an additional mechanism for defining and modifying musical audio waveform content.

Some embodiments of the present invention may also be implemented as a new sound source and thereby can work with and complement existing functionality, in effect adding a major new feature to various music related applications, and also enhancing user experience.

Some embodiments of the present invention may replace the current audio waveform (as a musical note) timbre defining/modifying tools that are native in a variety of platforms with a new, more flexible and easier to use functionality.

In addition, a studio application may incorporate a sound engine (10) according to some embodiments, for example, to provide dynamic input/editing tools as part of the studio application.

Additionally, music DJ applications may incorporate one or utilities or features based on some embodiments of the present invention. The ease of use and new timbre palette provided by the present invention fits well with the experimental nature of DJing.

By the use of precise, intricate and endlessly malleable Bezier paths to define/modify a musical note's audio waveform via a grid interface, some embodiments may create an environment where an audio waveform (as a note timbre) is a surprising combination of timbre control and expressiveness.

Further advantages associated with some embodiments include providing a strong dynamic experience. Moreover, the storing and sharing of timbre information as Bezier path descriptions that have infinite or near infinite resolution may have the unique ability of potentially driving any sound engine that uses any resolution. This cross-platform agility of Bezier timbre descriptions therefore has the potential to be a musical timbre description standard for the industry.

For music composers, some embodiments may provide the ability to work on an airplane using a laptop or tablet and define and modify audio waveforms.

Some embodiments may provide the ability to share in almost real time the lightweight and endlessly malleable Bezier timbre descriptions, with potentially any platform and sound engine anywhere in the world. This may enable a new intimacy of collaboration whereby a musician can share their timbre descriptions with another musician anywhere, and that recipient musician can also endlessly modify the descriptions with the same unprecedented degree of control that the sender musician enjoys.

Some embodiments may provide the ability to embed highly articulated and endlessly malleable Bezier path-based timbre descriptions into synthesizer keyboard patches (e.g. files that define the note attributes of any given keyboard key) that, being lightweight, can be shared in almost real time with other synthesizer keyboards. The receiving keyboard would then have the ability to precisely modify the timbre descriptions by manipulating the embedded paths.

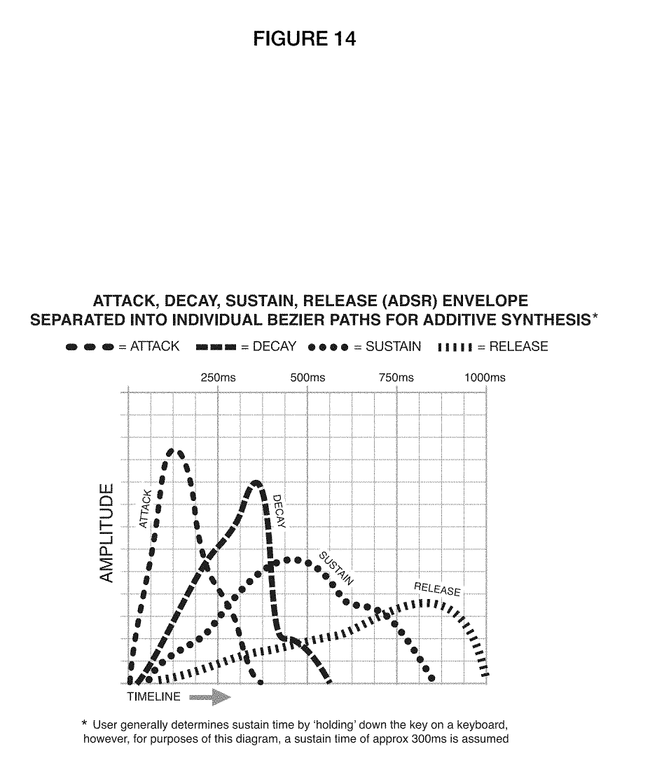

Some embodiments may also provide the possibility of assigning a highly articulated and highly malleable path to each of the Attack, Decay, Sustain, Release (ADSR) envelope (as shown in FIG. 14). This is a significant departure from the one continuous path for all four ADSR descriptions as used in prior systems. This is applicable to additive synthesis and may allow for the defining and modification of the ADSR in ways that are not possible using prior systems.

Some embodiments may provide precise control over audio waveforms, and provide a palette with an infinite range of timbre possibilities. The interfaces provided herein may provide precise control over audio waveforms, and the ability to create, modify and generate previously inexpressible audio waveforms, allowing for the exploration of new sounds.

It should be appreciated that other variations of the embodiments described herein may also be practiced without departing from the scope of the invention. Other modifications are therefore possible. It should be understood that the present invention may be implemented in a number of different ways. For example, variants may use different collaborative technologies, data frameworks, mobile technologies, web presentment technologies, content enhancement tools, document summarization tools, translation techniques and technologies, semantic tools, data modeling tools, communication technologies, web technologies, and so on. The present invention could also be integrated into one or more of such third party technologies, or such third party technologies could be modified to include the functionality described herein.

Several embodiments are specifically illustrated and/or described herein. However, it will be appreciated that modifications and variations are covered by the above teachings and within the scope of the appended claims without departing from the spirit and intended scope thereof. Various embodiments of the invention include logic stored on computer readable media, the logic configured to perform methods of the invention.

The embodiments described herein are illustrative of the present invention. As these embodiments of the present invention are described with reference to illustrations, various modifications or adaptations of the methods and or specific structures described may become apparent to those skilled in the art All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A system for generating and/or modifying sound entities, the system comprising:
one or more processors configured to provide a sound processing utility for generating and/or modifying sound entities;
one or more computers linked to or accessible by the sound processing utility,
a display connected to the one or more computers;
wherein the sound processing utility is configured to present on the display one or more graphical user interfaces for waveform generation/modifying, wherein the one or more graphical user interfaces include a graphical map of one or more audio elements as parametric representations,
wherein the parametric representations are encoded with information elements corresponding to audio timbre elements,
wherein the parametric representations and the encoded information elements are definable and/or modifiable by the graphical user interface so as to enable generation and modifying of the sound entities,
wherein the audio elements comprise the sound's timbre, such as frequency, pitch and amplitude envelopes, harmonic structure (i.e. overtone phase or micro tuning offsets), the timing or pitch of component waveform elements, or directly upon the waveform, and the parametric representations defined using Bezier paths.

2. The system of claim 1, wherein the parametric representations comprise parametric curves that define a path of curves and or lines.

3. The system of claim 1, further comprising one or more audio processing components operable to play the sound entities.

4. The system of claim 3, wherein the parametric representations encapsulate information for displaying a path on the interface, and also encapsulate the information for playing the sound entities, and wherein the parametric representations are definable or modifiable based on user input to the interface such that definitions/modifications of the parametric representations make corresponding changes to the information for playing the sound entities.

5. The system of claim 1, wherein the parametric representations are generated using one or more processes that create scalable parametric paths, such that the encoding of the parametric representations with the information elements is scalable.

6. The system of claim 1, wherein the sound processing utility creates calculation points for a parametric representation corresponding to the musical elements into a Bezier path, which may include line segments, the utility stores the path, and if input is received from the interface to modify the parametric representation, calculation points (“nodes”) may be added or removed from the Bezier path, or currently existing nodes may be adjusted, corresponding to such input, thereby enabling the modification of the sound entities such that smooth transitions are audible when the sound entities are played using an audio processing component.

7. The system of claim 1, wherein the graphical user interface provides a waveform defining and modifying tool.

8. The system of claim 7, wherein the interface includes one or more grids, each grid may include a timeline, and receiving input at the interface to create parametric representations and placing them in the timeline so as to define or modify an audio waveform's timbre.

9. The system of claim 8, the one or more grids include an amplitude grid, wherein the amplitude grid is executable to allow one or more users to draw on the amplitude grid one or more paths corresponding to a waveform, so as to create a spatial representation of amplitude attributes of sound elements that correspond to an associated amplitude spectrum.

10. The system of claim 9, wherein the length of the path may define the duration of a definition or modification.

11. The system as claim 9, wherein the one or more grids further include a frequency grid, that is executable to allow one or more users to draw on the frequency grid one or more paths corresponding to a note so as to create a spatial representation of frequency attributes of sound elements that correspond to an associated frequency spectrum.

12. The system as claim 9, wherein the one or more grids further include a phase overtone grid that is executable to allow one or more users to draw on the phase overtone grid one or more paths corresponding to a note so as to create a spatial representation of phase overtone attributes of sound elements that correspond to an associated phase overtone spectrum.

13. The system as claim 9, wherein the one or more grids further include a relative pitch of overtone grid that is executable to allow one or more users to draw on the relative pitch of overtone grid one or more paths corresponding to a note so as to create a spatial representation of relative pitch of overtone attributes of sound elements that correspond to an associated relative pitch of overtone spectrum.

14. The system as claim 9, wherein the one or more grids further include a resonance grid that comprise a bandwidth x axis and amplitude y axis, wherein the grid is executable to allow one or more users to draw on the resonance grid one or more paths corresponding to a note so as to create a spatial representation of resonance attributes of sound elements that correspond to an associated resonance spectrum.

15. A computer implemented method for defining or modifying sound entities, the method comprising:
displaying one or more definition/modification graphical user interfaces implemented to one or more computers including or being linked to a touch screen display;
receiving one or more selections relevant to one or more musical timbre elements using the interface, the musical elements define or modify aspects of the note's timbre, such as its frequency, pitch and amplitude envelopes, harmonic structure, the timing or pitch of component waveform elements, or directly upon the waveform;
generating one or more parametric paths corresponding to the selections and encoding the musical elements, the parametric paths defined using Bezier paths (which may include line elements); and
storing the parametric paths so as to define one or more executable sound entities, wherein the sound entities can be defined or modified using the graphical user interface so as to enable the defining or modifying of the sound entities.

16. A computer implemented method for defining or modifying sound entities, the method comprising:
displaying one or more timbre definition/modification graphical user interfaces implemented to one or more computers including or being linked to a touch screen display, wherein the interface includes one or more grids that define or modify aspects of the note's timbre, such as its frequency, pitch and amplitude envelopes, harmonic structure, the timing or pitch of component waveform elements, or directly upon the waveform;
receiving one or more selections relevant to one or more musical timbre elements using the interface;
generating one or more parametric paths corresponding to the selections and encoding the musical elements;
storing the parametric paths so as to define one or more executable sound entities, wherein the sound entities can be defined or modified using the graphical user interface so as to enable the defining or modifying of the sound entities accessing the audio timbre grids, so as to define or modify aspects of the sound's timbre for the sound entities;
receiving input using the graphical user interface that the definition or modification of aspects of the sound's timbre have been completed; and
storing the one or more sound entities defined by the selection of aspects of the sound's timbre to a data store, thereby providing the one or more executable sound entities based on such sound attributes.

17. The method of claim 15, further comprising: playing the one or more sound entities, wherein the parametric paths encapsulate information for playing the sound entities.

18. The method of claim 15, further comprising displaying the parametric path on the interface, and wherein the parametric paths are modifiable based on input at the interface such that modifications to the parametric paths make corresponding changes to the information for playing the sound entities.

19. The method of claim 16, further comprising: playing the one or more sound entities, wherein the parametric paths encapsulate information for playing the sound entities.

20. The method of claim 16, further comprising displaying the parametric path on the interface, and wherein the parametric paths are modifiable based on input at the interface such that modifications to the parametric paths make corresponding changes to the information for playing the sound entities.

21. The method of claim 15, wherein the interface includes one or more grids, each grid comprising a timeline, and the method further comprises receiving input at the interface to create the parametric paths and placing them in the timeline so as to define or modify a sound's waveform.

22. The method of claim 16, wherein each grid comprises a timeline, and the method further comprises receiving input at the interface to create the parametric paths and placing them in the timeline so as to define or modify a sound's waveform.

23. The method of claim 15, wherein the length of the parametric path defines the duration of a definition/modification.
